(19) United States
(12) Patent Application Publication
(10) Pub. No.: US 2026/0040394 A1
(43) Pub. Date: Feb. 5, 2026

(54) METHODS FOR CONFIGURING SIDELINK DISCONTINUOUS RECEPTION OF A REMOTE WIRELESS DEVICE, A RELATED RELAY WIRELESS DEVICE AND A RELATED REMOTE WIRELESS DEVICE

(71) Applicant: Sony Group Corporation, Tokyo (JP)

(72) Inventors: Torgny PALENIUS, Barsebäck (SE); Anders BERGGREN, Lund (SE); Lars NORD, Lund (SE)

(21) Appl. No.: 18/998,281

(22) PCT Filed: Aug. 7, 2023
(86) PCT No.: PCT/EP2023/071824

§ 371 Date: Jan. 24, 2025

(30) Foreign Application Priority Data
Aug. 5, 2022 (SE) 2250953-3

(51) Int. Cl. H04W 76/28; H04W 88/04; H04W 92/18

(52) U.S. Cl. CPC H04W 76/28; H04W 88/04; H04W 92/18

(57) ABSTRACT

Disclosed is a method, performed in a relay wireless device, WD, for configuring sidelink discontinuous reception, DRX, of a remote WD. The method comprises receiving, from the remote WD, a first signal, the first signal being indicative of a request to initiate sidelink communication with the relay WD. The method comprises determining a DRX configuration to be used for communication between the relay WD and the remote WD. The method comprises transmitting, to the remote WD, a second signal, the second signal being indicative of the DRX configuration to be used.

The present disclosure pertains to the field of wireless communications. The present disclosure relates to a method for configuring sidelink discontinuous reception, DRX, of a remote wireless device, a related relay wireless device and a related remote wireless device.

### BACKGROUND

The 3^{rd} Generation Partnership Project, 3GPP, Release 17, sidelink enhancements are currently being developed. Sidelink refers to device to device (D2D) communication between devices of a plurality of wireless devices (WDs). Sidelink communication has different modes, or casts, of communication. These modes, or casts, are unicast (between two WDs), groupcast (between all WDs belonging to a group, such as a sidelink group), and broadcast (between all WDs connected to a sidelink cluster. A sidelink cluster can herein be seen as a communication area in which the sidelink configuration is valid.

A WD which is attached to or camping at a cell of a 3GPP radio network node, such as over a Uu interface, may use a first Discontinuous Reception (DRX) configuration in any DRX mode, such as an Idle state, an Inactive state or a Connected mode DRX. The DRX configuration defines a DRX cycle comprising an active time, and an inactive time. The active time can be seen as an ON time or an ON duration, in which the WD wakes up, such as enters a Radio Resource Control (RRC) Connected state, to listen for messages. The inactive time can be seen as, an OFF time, such as an idle period, in which the WD may go to sleep, such as enter a power saving mode or a dormant mode. The ON time of the DRX cycle may herein be referred to as a DRX occasion. In the power saving mode, the WD may power down most of its circuitry, such as may turn off its transceiver, in order to reduce its power consumption. If the WD is simultaneously monitoring or transmitting during a sidelink resource pool (as defined in TS 38.331 v16.4.1) designated for the DRX activities over sidelink using a second DRX configuration, the WD may be required to wake up at a plurality of DRX occasions to listen for messages, which reduces the amount of time when the WD may sleep, which increases the power consumption of the WD. The sidelink resource pool may herein be seen as a pool of resources, such as a set of resources in time and frequency, to be used for sidelink communication. The sidelink resource pool may comprise a pool of transmit (Tx) resources, such as a transmit resource pool (TxPool), and/or a pool of receive (Rx) resources, such as a receive resource pool (RxPool), that may be used for the sidelink transmission.

For Sidelink DRX unicast, the connection between two WDs is initiated by a Direct Discovery procedure between a transmitting (Tx) WD (such as the WD that initiates the connection) and a receiving (Rx) WD. Once the connection has been initiated by the Tx WD, the Rx WD may signal its capabilities and a preferred DRX configuration regarding, for example, timing and period of the DRX. Then, the Tx WD sends a DRX configuration to the Rx WD which it may accept or reject.

For sidelink relay, such as when a first WD, such as a relay WD, relays communication to and/or from a second WD, such as a remote WD not being in coverage of a radio network node, the above approach where the Tx WD always determines the DRX timing can be problematic. If a plurality of remote WDs initiate sidelink communication, such as communication via a PC5 interface with the relay WD, the relay WD may receive different DRX configurations, such as DRX timing, from each of the remote WDs. The relay WD may thereby end up with a DRX scheme that causes the relay WD to monitor the PC5 link in a plurality of different time slots. This may result in an increased power consumption for the relay WD since the relay WD has to be awake to monitor the respective DRX occasions of the plurality of remote WDs, thereby reducing the time the relay WD can power down its circuitry to save power. Typically, it is the remote WD that realizes that it requires a relay WD, and initiates the sidelink communication with the relay WD.

### SUMMARY

Accordingly, there is a need for devices and methods for configuring sidelink discontinuous reception (DRX) of a remote WD, which may mitigate, alleviate or address the shortcomings existing and may reduce power consumption of a relay WD relaying data via sidelink.

Disclosed is a method, performed in a relay wireless device, WD, for configuring sidelink discontinuous reception, DRX, of a remote WD. The method comprises receiving, from the remote WD, a first signal, the first signal being indicative of a request to initiate sidelink communication with the relay WD. The method comprises determining a DRX configuration to be used for communication between the relay WD and the remote WD. The method comprises transmitting, to the remote WD, a second signal, the second signal being indicative of the DRX configuration to be used.

Further, a relay WD comprising memory circuitry, processor circuitry, and a wireless interface is provided. The relay WD is configured to perform any of the methods disclosed herein.

It is an advantage of the present disclosure that the relay WD can determine the DRX configuration to be used for the sidelink communication with the remote WD when the relay WD is a receiving WD and the sidelink connection is initiated by the remote WD. The relay WD can thus configure the DRX configuration of one or more remote WDs to reduce the active time of the relay WD. The relay WD can, for example, align the DRX configuration, such as the active time of the DRX configuration, of the remote WD with DRX configurations, such as the active time of the DRX configurations, of other nodes communicating with the relay WD, such as with a radio network node and/or one or more other remote WDs. Thereby, the relay WD can reduce the active time of the relay WD when communicating with one or more remote WDs and increase the time the relay WD can power down its circuitry to save power.

Disclosed is a method, performed in a remote wireless device, WD, for configuring sidelink discontinuous reception, DRX, of the remote WD. The method comprises transmitting, to a relay WD, a first signal, the first signal being indicative of a request to initiate sidelink communication with the relay WD. The method comprises receiving, from the relay WD, a second signal, the second signal being indicative of a DRX configuration to be used.

Further, a remote WD comprising memory circuitry, processor circuitry, and a wireless interface is provided. The remote WD is configured to perform any of the methods disclosed herein.

It is an advantage of the present disclosure that the relay WD can determine the DRX configuration to be used for the sidelink communication between the remote WD and the relay WD when the remote WD initiates the sidelink connection between the remote WD and the relay WD. The relay WD can thus configure the DRX configuration of the remote WD to reduce the active time of the relay WD. The relay WD can, for example, align the DRX configuration, such as the active time of the DRX configuration, of the remote WD with DRX configurations, such as the active time of the DRX configurations, of other nodes communicating with the relay WD, such as with a radio network node and/or one or more other remote WDs. Thereby, the relay WD can reduce the active time of the relay WD and increase the time the relay WD can power down its circuitry to save power.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node, an example relay wireless device and a plurality of example remote wireless devices according to this disclosure,

FIG. 2 is a diagram illustrating a DRX cycle of the relay WD and a set of remote WDs using a legacy method for configuring DRX in sidelink,

FIG. 3 is a diagram illustrating a DRX cycle of the relay WD and a set of remote WDs using the method for configuring DRX in sidelink according to this disclosure,

FIG. 4 is a signalling diagram illustrating an example communication between an example relay wireless device and an example remote wireless device according to this disclosure,

FIG. 5 is a flow-chart illustrating an example method, performed in a relay wireless device, for configuring sidelink discontinuous reception, DRX, of a remote wireless device according to this disclosure,

FIG. 6 is a flow-chart illustrating an example method, performed in a remote wireless device, for configuring sidelink discontinuous reception, DRX, of the remote wireless device according to this disclosure,

FIG. 7 is a block diagram illustrating an example relay wireless device according to this disclosure, and

FIG. 8 is a block diagram illustrating an example remote wireless device according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

The figures are schematic and simplified for clarity, and they merely show details which aid understanding the disclosure, while other details have been left out. Throughout, the same reference numerals are used for identical or corresponding parts.

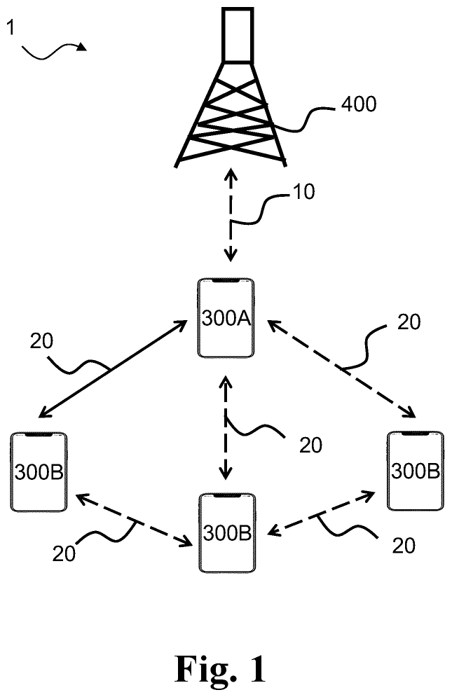

FIG. 1 is a diagram illustrating an example wireless communication system 1 comprising an example radio network node 400 and a set of wireless devices (WDs) 300, such as an example relay WD 300A and one or more remote WDs 300B according to this disclosure.

As discussed in detail herein, the present disclosure relates to a wireless communication system 1 comprising a cellular system, for example, a 3GPP wireless communication system.

A radio network node 400 disclosed herein refers to a network node operating in the radio access network (RAN), such as a base station, an evolved Node B, eNB in Evolved Universal Mobile Telecommunications System (UMTS) Terrestrial Radio Access (E-UTRA), gNB in NR. In one or more examples, the RAN node is a functional unit which may be distributed in several physical units.

The wireless communication system 1 optionally comprises an example core network (CN) node (not shown in FIG. 1). A core network node disclosed herein refers to a network node operating in the core network, such as in the Evolved Packet Core Network, EPC, and/or a 5G Core Network, 5GC. Examples of CN nodes include a Mobility Management Entity (MME) and an Access and Mobility Management Function (AMF). In one or more examples, the CN node is a functional unit which may be distributed in several physical units.

The wireless communication system 1 described herein may comprise one or more wireless devices 300, 300A, 300B, and/or one or more radio network nodes 400, such as one or more of: a base station, an eNB, a gNB and/or an access point.

A wireless device may refer to a mobile device and/or a user equipment (UE).

The wireless devices 300; 300A, 300B may be configured to communicate with the radio network node 400 via a wireless link (or radio access link) 10, 10A, such as a Universal Mobile Telecommunications System air (Uu) interface. The wireless devices 300; 300A, 300B may be configured to communicate directly with each other via a sidelink 20, such as without communicating via the radio network node 400. The sidelink 20 may be a wireless link.

The core network node may be configured to communicate with the radio network node 400 via a link, such as a wired and/or wireless link, and/or with the one or more wireless devices 300, 300A, via the radio network node 400.

The current disclosure relates to methods for configuring sidelink DRX, such as a DRX cycle for the sidelink, or sidelink communication, 20 of a remote WD 300B.

In the 3^{rd} Generation Partnership Project (3GPP) sidelink Rel-17, DRX is introduced for unicast, groupcast and broadcast between a plurality of WDs, such as via the sidelink 20. A sidelink WD, such as a WD 300A, 300B communicating with another WD over sidelink 20, can monitor every configured RxPool. An RxPool can herein be seen as a set of resources in time and frequency where sidelink communications, such as sidelink transmission and/or reception, are defined. In the DRX mode the WD 300A, 300B only needs to monitor a subset of the sidelink RxPools defined by the DRX scheme, and a transceiver of the WD 300A, 300B, such as a transmitter and/or receiver of the WD 300A, 300B, can sleep, such as can be powered down, between the DRX occasions of these sidelink RxPools.

In 3GPP Rel. 17 for sidelink DRX unicast, the connection between two WDs is initiated by a Direct Communication procedure between a transmitting (Tx) WD (the WD which initiates the connection) and a receiving (Rx) WD. Once the connection has been initiated by the Tx WD, the Rx WD may signal its capabilities and a preferred DRX configuration regarding for example timing and period of the DRX. Then the Tx WD sends a DRX configuration to the Rx WD which may accept or reject the DRX configuration.

The Rx WD signals the preferred DRX cycle to the Tx WD in a UEAssistanceInformationSidelink procedure (3GPP TS 38.331 chapter 5.8.9.6). The DRX configuration from the Tx WD can be signaled in an RRCReconfigurationSidelink procedure (38.331 chapter 5.8.9.1).

In this way the Tx WD can configure a DRX configuration for sidelink on the PC5 interface in which an active time for sidelink can be aligned with a Uu DRX scheme of the Tx WD, in case the Tx WD is in Idle state, Inactive state or in C-DRX on the Uu link. The Uu link is the interface between a WD and a radio network node, such as a base station, such as a gNB. The sidelink DRX configuration includes a time slot offset and a periodically occurring time-period, such as an active time period, to monitor reception and transmission of data.

For the Uu link, the DRX timing in Idle and Inactive state can be calculated according to the definitions in 3GPP TS 38.304, section 7.1, which states that the Paging Frame (PF) and Paging Occasion (PO) for paging are determined by the following formulae:

A system frame number (SFN) for the PF is determined by:

$$( S F N + PF\_offset ) mod T = ( T div N ) * ( UE\_ID mod N )$$

An index (i_s), indicating the index of the PO is determined by:

$$i\_s = floor ( ( UE\_ID / N ) mod Ns ,$$

where N is a number of total paging frames in the DRX cycle T of the WD 300A, 300B, Ns is the number of paging occasions for a PF, PF_offset is an offset used for PF determination, and UE_ID is an identifier for identifying the WD, such as a Temporary Mobile Subscriber Identity, such as a 5G-S-TMSI.

Following the above logic where the sidelink DRX scheme is linked to the Uu DRX scheme, the paging occasion in sidelink Rel. 17 is based on the temporary mobile subscriber ID, S-TMSI, of the WD. The S-TMSI may change when the WD sends a service request to the core network, thus when a WD in Idle state sends a registration update to the core network, or changes state to connected state to send or receive data and then goes back to the DRX state, the DRX timing of the WD may be changed.

For the Uu link the DRX timing for C-DRX configured for a WD in connected mode the active time may be configured from the radio network node, for example based on the parameter drx-StartOffset. C-DRX can have two states, such as an active state and an inactive state. When in inactive state either a short DRX timer or a long DRX timer may be running depending on configuration. For example, if a short DRX timer is configured and is expiring, a long DRX timer is started. The short DRX timer is optional, and can be used to avoid immediate action for the longer sleeping mode of the long DRX timer. An active time for a long DRX cycle starts when the statement below, as defined in 3GPP TS 38.321 section 5.7, is fulfilled:

$$[ ( SFN \times 10 ) + subframe number ] modulo ( drx - LongCycle ) = drx - StartOffset :$$

If a short DRX cycle is used, then the active time starts when the following statement is fulfilled:

$$[ ( SFN \times 10 ) + subframe number ] modulo ( drx - ShortCycle ) = ( drx - StartOffset ) modulo ( drx - ShortCycle ) :$$

Hence, for the Uu link the timing is defined, for both long and short DRX, by the parameter “drx-StartOffset”, and is configured by the network via radio resource control (RRC).

For sidelink relay, such as when a WD 300A relays communication between two other WDs 300B or between a WD 300B and the radio network node 400, the above approach where the Tx WD always determines the DRX timing can be problematic. For example, if a plurality of remote WDs 300B initiate sidelink communication, such as communication via the PC5 interface with the relay WD 300A, the relay WD 300A may receive different DRX timings from each of the remote WDs 300B. The relay WD 300A may thereby end up with a DRX scheme that causes the relay WD 300A to monitor the PC5 link in a plurality of time slots. This can result in an increased power consumption for the relay WD 300A since the relay WD 300A has to be awake to monitor the respective DRX occasions of the plurality of remote WDs 300B.

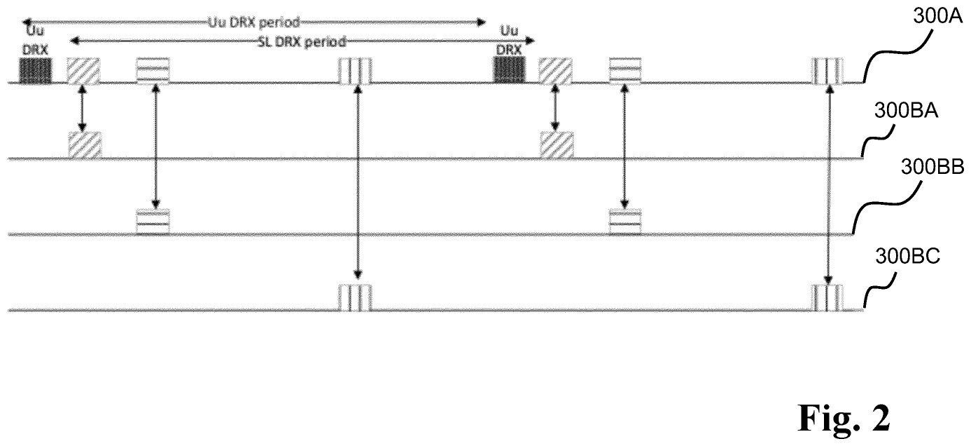

FIG. 2 shows the active time for a relay WD 300A when connected to a plurality of remote WDs 300B, such as a first remote WD 300BA, a second remote WD 300BB, and a third remote WD 300BC. The remote WDs 300BA, 300BB, and 300BC may have the same sidelink (SL) DRX period and different DRX timing, such as different timing of the DRX occasions, such as the active period of the DRX cycle. The remote WDs 300BA, 300BB, and 300BC are normally only connected with one relay WD 300A via sidelink 20. The connection over Uu interface 10 may be in RRC-Connected state or in a power save state, such as RRC-idle, RRC-Inactive or in a Power Saving Mode (PSM), depending on the data sent between the radio network node 400 and the remote WD 300BA, 300BB, and 300BC via the relay WD 300A. As can be seen in FIG. 2, the relay WD 300A also has Uu DRX occasions to handle while the remote WDs 300BA, 300BB, 300BC only communicate with the radio network node 400 via the relay WD 300A. Therefore, the remote WDs 300BA, 300BB, and 300BC consumes less power than the relay WD and can be less sensitive of the sidelink DRX timing than the relay WD 300. There is thus room for improvement of the DRX timing when communicating via a relay WD 300A in sidelink 20.

Specific support for sidelink relay between a WD 300BA, 300BB, and 300BC and the network for sidelink DRX is specified in Rel-17, in 3GPP TS 38.331 v. 17.1.0 and/or 3GPP TS 38.321 v. 17.1.0. In this case, the sidelink relay node, such as the relay WD 300A, may be in connected mode while it is relaying data and in Idle/Inactive mode when no data is sent even though the sidelink 20 is established. For example, for a solution where a home base station acts as a sidelink relay, the relay WD 300A may camp on the sidelink 20 prepared for a paging received from any remote WD sent on sidelink 20. The relay node may also be in connected DRX (C-DRX) on the Uu interface. The sidelink connection to each WD 300BA, 300BB, and 300BC may be in SL DRX mode to save power.

The relay WD 300A may also be power sensitive if it is a WD that is acting as a UE-to-UE relay between other WDs 300BA, 300BB, and 300BC in a sidelink group which is out of coverage from a mobile network, such as from a radio network node 400. In this case, one of the WDs placed centrally between all WDs in the group may act as a UE-to-UE relay for many of the connections, or for a group chat between all WDs in the sidelink group.

In 3GPP Rel-18 work is ongoing on UE-to-UE relay, where two WDs, which are not in sidelink coverage to each other, can communicate via a third WD, such as a relay WD, without sending the data via the network. For this type of relay, power consumption can be important. The relay WD may, in this case, be in RRC Idle or Inactive state on the Uu interface since the relay data is sent to another WD on the PC5 interface. Therefore, for each WD there is a respective Idle state and/or Inactive state DRX cycle to consider when configuring the sidelink. The relay WD is more sensitive to the timing of the DRX cycle than the remote WD since the relay WD has to be able to relay data to and/or from a plurality of WDs. If the remote WDs are power-sensitive, the DRX on the Uu interface may be configured to be very sparse, such as may have a long DRX period, such as enhanced DRX, eDRX.

According to the current disclosure, when a WD is a sidelink relay node to other remote UEs, such as is a relay WD 300A, the relay WD 300A may have priority to decide the DRX timing to the remote WDs 300BA, 300BB, 300BC. This allows the relay WD 300A to align the sidelink DRX schemes both to its paging occasions on the Uu interface and to the DRX schemes of other remote WDs 300BA, 300BB, 300BC with sidelink configurations to the relay WD 300A.

The relay WD 300A may be a relay for several remote WDs 300BA, 300BB, 300BC. The remote WDs may, for example, be Internet of Things (IoT) devices with limited power that may communicate with a WD which is placed close to the IoT devices instead of communicating with the network, such as with the radio network node 400, which may be located further away.

The relay WD 300A may consider DRX preferences, such as desired DRX configurations, from the remote WDs 300BA, 300BB, 300BC to determine how to optimize and minimize the power consumption for all involved WDs.

There may be a plurality of remote WD 300BA, 300BB, 300BC connected via sidelink 20 to the relay WD 400 using sidelink DRX. The relay WD 300A may be configured to align the sidelink DRX cycles of the different sidelink connections to the remote WD 300BA, 300BB, 300BC to limit the duty cycle of the sidelink connections, handle latency requirements of the relay communication and coordinate the sidelink activities based on limitations with capabilities in the relay WD 300A, etc.

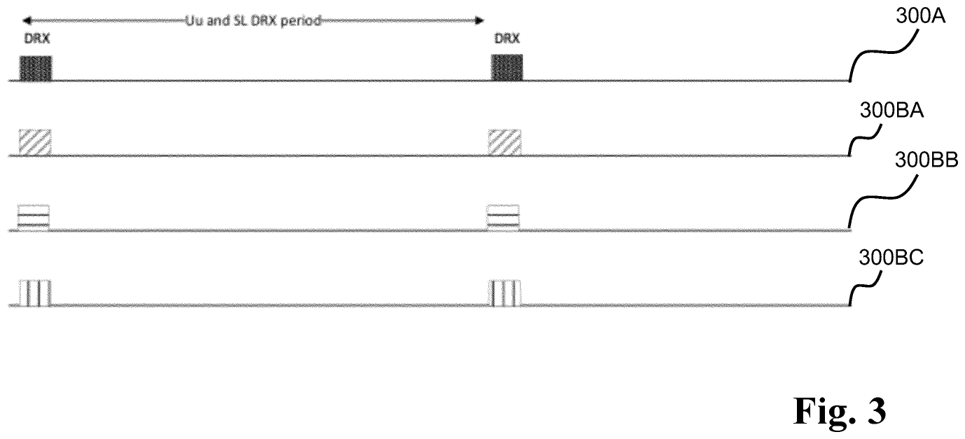

FIG. 3 shows an example DRX configuration for the plurality of remote WDs 300BA, 300BB, 300BC according to one or more examples of the current disclosure. In the example shown in FIG. 3, the relay WD 300A configures the sidelink DRX of the remote WDs 300BA, 300BB, 300BC to be aligned with the Uu DRX of the relay WD 300A, such that the sidelink DRX for the remote WDs 300BA, 300BB, 300BC and the Uu DRX have the same DRX timing and DRX period. Thereby, the active time can be reduced for the relay WD 300A and for the remote WDs 300BA, 300BB, 300BC.

The relay WD 300A can be an Rx and/or a Tx WD. The relay WD 300A may be an Rx WD when the remote WD 300BA, 300BB, 300BC is initiating the communication to either the NW or to another WD over the relay WD. The relay WD 300A may be a Tx WD when the relay WD 300A initiates a communication with the remote WD based on that the relay WD 300A has data to send to the remote WD 300BA, 300BB, 300BC in coverage of the relay WD 300A. According to the current disclosure, the relay WD 300A decides on the DRX configuration for the remote WDs 300BA, 300BB, 300BC, independent of whether the relay WD 300A is the Tx WD or Rx WD. In comparison to the legacy solution disclosed in FIG. 2, this allows the relay WD to align the DRX occasions of the plurality of remote WDs 300BA, 300BB, 300BC and/or the Uu DRX, so that the relay WD can monitor a plurality of the channels for communication, such as the respective channels to the plurality of remote WDs 300BA, 300BB, 300BC and/or to the radio network node vi the Uu interface.

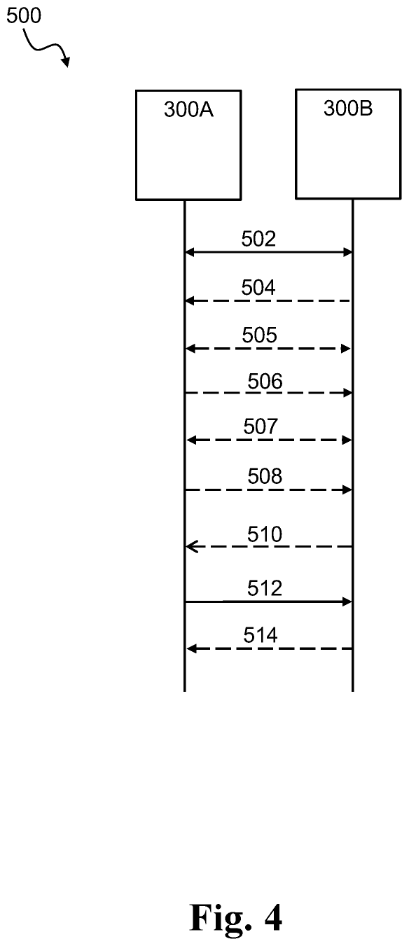

FIG. 4 shows an example signaling diagram 500 for configuring sidelink DRX for an example remote WD 300B according to one or more examples herein. The remote WD 300B may be any one of the remote WDs 300BA, 300BB, and/or 300BC as disclosed in FIG. 2 or 3. In the example shown in FIG. 4, the relay WD 300A may be an Rx WD.

The remote WD 300B may initiate communication 502 with the relay WD 300A. In accordance with the definition in 3GPP TS 38.331, the remote WD 300B would, in this case, be considered to be the Tx WD. The communication may, for example, be initiated using a Direct Communication procedure. The remote WD 300B may already be aware that the relay WD 300A is a relay, for example by preconfiguration or if the relay WD 300A has broadcasted its capability as a relay UE previously. Else the remote WD 300B may need to perform a discovery procedure to discover any relay WDs 300A within the current location of the remote WD 300B.

In one or more example methods, the remote WD 300B may signal a proposed first DRX configuration 504 to the relay WD 300A. The proposed first DRX configuration 504 may, in one or more example methods, be provided in a UEAssistanceInformationSidelink message.

In one or more example methods, the remote WD 300B may signal its capabilities 505, such as its capabilities for sidelink DRX to the relay WD 300A. In contrast to the legacy solution, the remote WD 300B acts as a Tx WD when sending the proposed DRX configuration, instead of as an Rx WD. The capabilities of the remote WD 300B may be indicative of one or more of the remote WD's capability to use sidelink DRX at all, and the remote WD's radio capability for sidelink. These capabilities may be communicated to the other WDs in the sidelink in order to set up the sidelink communication between the WDs. The capabilities of the remote WD may be signaled in response to a capability request message, such as a UECapabilityEnquirySidelink message, received from the relay WD. The capabilities may, in one or more example methods, be signaled in a UECapabilityInformationSidelink.

In one or more example methods, the relay WD 300A sends a signal 506 to the remote WD 300B comprising an indication indicating that since relay WD 300A is a relay WD it will, instead of just signaling a preferred DRX configuration, send a proposed DRX configuration comprising the DRX timing. The signal 506 may, in one or more example methods, be provided in a UEAssistanceInformationSidelink message.

In one or more example methods, the relay WD 300A may signal its capabilities 507 for sidelink DRX to the remote WD 300B. The capabilities of the relay WD 300A may be indicative of one or more of the relay WD's capability to use sidelink DRX at all, and the relay WD's radio capability for sidelink. These capabilities may be communicated to the other WDs in the sidelink in order to set up the sidelink communication between the WDs. The capabilities of the remote WD may be signaled in response to a capability request message, such as a UECapabilityEnquirySidelink message, received from the relay WD. The capabilities may, in one or more example methods, be signaled in a UECapabilityInformationSidelink. The relay WD 300A may then transmit a third signal being indicative of a second proposed DRX configuration 508 to the remote WD 300B. Contrary to the legacy solution, this second proposed DRX configuration 508 is transmitted by the Rx WD instead of the Tx WD. The second proposed DRX configuration 508 may be transmitted in an RRCReconfigurationSidelink message.

The remote WD 300B sends a response message 510 in response to the second proposed DRX configuration 508. In one or more example methods, the response message 510 may comprise an indication that the remote WD 300B accepts and/or confirms the second proposed DRX configuration 508 from the remote WD 300A. The remote WD 300B may, in one or more example methods, signal its capabilities on sidelink DRX to the relay WD. The capabilities may be signaled in the response message 510 or in a separate message 511, in a UECapabilityInformationSidelink message. When the remote WD 300B accepts the proposed DRX configuration in the second proposed DRX configuration 508, the response message 510 may be an RRCReconfigurationCompleteSidelink message. The capabilities of the remote WD may be signaled in response to a capability request message, such as a UECapabilityEnquirySidelink message, received from the relay WD. The capabilities may, in one or more example methods, be signaled in a UECapabilityInformationSidelink message. In other words, the relay WD may ask the remote WD if it supports SL DRX. The remote WD may, in one or more example methods, respond with Yes or No, which would be indicative of the remote WD's capability.

In one or more example methods, the response message 510 may comprise an indication that the remote WD 300B rejects the second proposed DRX configuration 508 from the remote WD 300A. The remote WD 300B may, in one or more example methods, signal its capabilities on sidelink DRX to the relay WD 300A and/or propose a different DRX configuration to the relay WD 300A. The capabilities on sidelink DRX and/or the proposed different DRX configuration may be signaled to the relay WD 300A in the response message 510 and/or in the separate message 511. When the remote WD 300B rejects the proposed DRX configuration, the response message 510 may be an RRCReconfigurationFailureSidelink message.

The relay WD 300A sends a second signal indicative of a DRX configuration to be used 512 to the remote WD 300B. In one or more example methods, the DRX configuration to be used may be sent to the remote WD 300B upon the remote WD 300B rejecting the second proposed DRX configuration 508. The DRX configuration to be used may, in one or more example methods, be based on the remote WDs 300B proposal and/or capabilities. The DRX configuration to be used can herein be seen as the relay WD 300A having the final decision on the DRX configuration that is to be used for sidelink communication with the relay WD 300A and instructs the remote WD 300B to use the DRX configuration when communicating with the relay WD 300A. The DRX configuration to be used 512 may be transmitted in an RRCReconfigurationSidelink message.

The remote WD 300B may send an accept message 514 to the relay WD 300A comprising an indication indicating that the remote WD 300B accepts and/or confirms the DRX configuration to be used.

In case the relay WD 300A communicates its temporary identifier, such as an S-TMSI on the Uu interface, the DRX cycle on the Uu interface, such as the idle and inactive state DRX timing, may change. If that is the case and the relay WD 300A wants the timing of the sidelink DRX to change it may send reconfiguration requests to the one or more connected remote WDs 300B with a new DRX configuration for sidelink which is aligned with the new DRX cycle of the Uu cycle of the relay WD 300A.

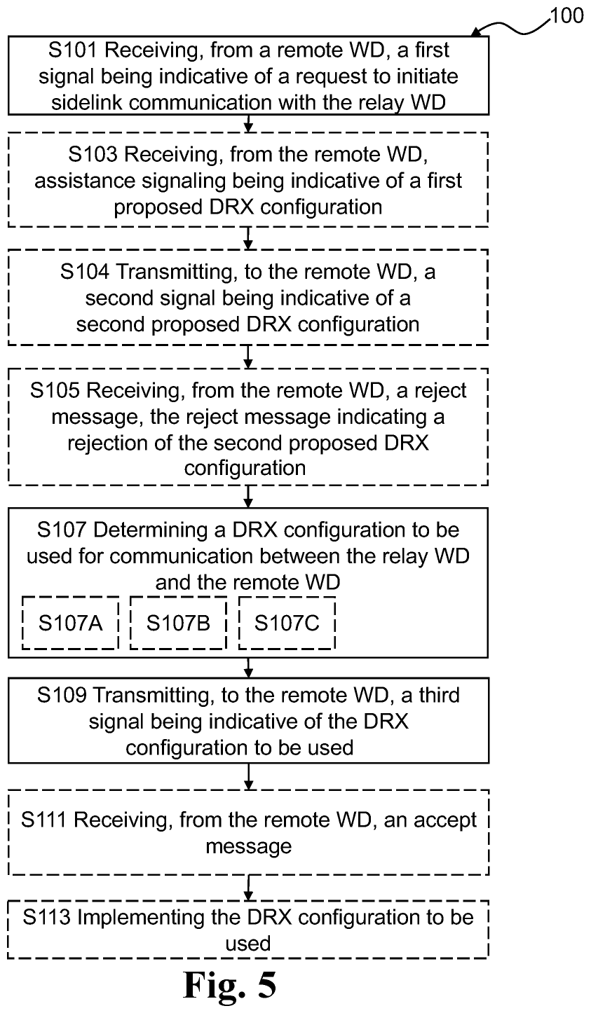

FIG. 5 is a flow-chart illustrating an example method 100, performed in a relay wireless device, WD, according to the disclosure, for configuring sidelink discontinuous reception, DRX, of a remote WD. The relay WD is the relay WD disclosed herein, such as relay WD 300A of FIGS. 1, 3-4, and FIG. 7.

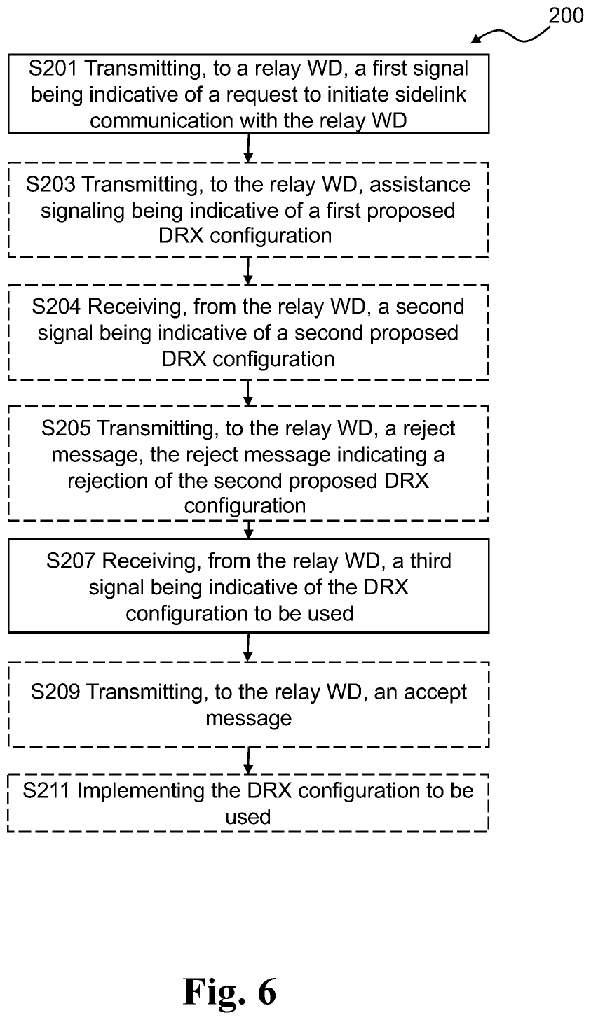

The method 100 comprises receiving S101, from the remote WD, a first signal. The first signal is indicative of a request to initiate sidelink communication with the relay WD. The first signal may be received via control signaling. In one or more example methods, the first signal may be received as part of a Direct Communication procedure. This step S101 corresponds to step S201 of FIG. 6 and is similar to 502 of FIG. 4.

In one or more example methods, the method 100 comprises receiving S103, from the remote WD, such as from a first remote WD, assistance signaling. The assistance signaling may be indicative of assistance information assisting the relay WD in determining a DRX configuration to be used for communication between the remote WD and the relay WD via sidelink. In one or more example methods, the assistance information may comprise preferred DRX parameters of the remote WD. In one or more example methods, the assistance signaling is indicative of a first proposed DRX configuration for communication between the relay WD and the remote WD. The first proposed DRX configuration may be a DRX configuration desired by the remote WD. In one or more example methods, the assistance signaling may be a UEAssistanceInformationSidelink message as defined in 3GPP TS 38.331, chapter 5.8.9.6. The DRX configuration may comprise one or more of a DRX timing and a DRX period. The DRX timing can herein be seen as the triggering condition of the DRX cycle. The DRX timing may be indicative of an active period of the DRX cycle, such as a period in which the WDs are configured to monitor for signals, such as paging signals and/or data to be retransmitted. The DRX cycle can be seen as the time between a first active period and a second active period. Each DRX cycle may comprise an active period and an inactive period. During the inactive period the WD, such as the remote WD and/or the relay WD, may power down most of its circuitry when there are no data packets to be received or transmitted. In one or more example methods, the assistance signaling comprises WD capabilities for sidelink DRX of the remote WD. This step S103 corresponds to 504 of FIG. 4 and step S203 of FIG. 6.

In one or more example methods, the method 100 comprises transmitting S104, to the remote WD, a third signal being indicative of a second proposed DRX configuration for communication between the relay WD and the remote WD. In one or more example methods, the relay WD may reject the first proposed DRX configuration received from the remote WD and may instead provide the second proposed DRX configuration to the remote WD which improves the power consumption of the relay WD, such as reduces the active time of the relay WD during a DRX cycle. The second proposed DRX configuration may, in one or more example methods, be determined by the relay WD based on one or more of the assistance signaling received from the remote WD, proposed DRX configurations from other remote WDs, and the relay WD's own DRX configuration over the Uu interface. This step S104 corresponds to 508 of FIG. 4 and step S204 of FIG. 6.

In one or more example methods, the second DRX configuration is based on the assistance signaling received from the remote WD. In one or more example methods, the relay WD may determine the DRX configuration to be used based on the capabilities for sidelink DRX and/or the first proposed DRX configuration received from the remote WD.

In one or more example methods, the second DRX configuration is based on a current DRX configuration of the relay WD. The current DRX configuration may for example be a Uu DRX configuration of the relay WD, such as a DRX configuration for the communication with the radio network node via the Uu interface. This may be the case when the relay WD is connected to the radio network node via the Uu interface.

In one or more example methods, the second DRX configuration is based on a current DRX configuration of a second remote WD. In case the relay WD has already established a sidelink connection with a second WD, the relay WD may determine the DRX configuration for the first WD, such as for the remote WD from which the request to initiate sidelink communication with the relay WD was received, based on an already existing DRX configuration for the second WD. In one or more example methods, the relay WD may determine the DRX configuration of the remote WD, such as of the first remote WD, to correspond to the DRX configuration of the second remote WD. The DRX configurations of the first remote WD and the second remote WD may thus overlap, such that the PFs and/or the POs of the first remote WD and the second remote WD overlap.

In one or more example methods, the method 100 comprises receiving S105, from the remote WD, a reject message. The reject message may be indicative of a rejection of the proposed DRX configuration received from the relay WD. In one or more example methods, the reject message may comprise one or more of the remote WD's capabilities on sidelink DRX and a different proposed DRX configuration, such as a third proposed DRX configuration. The reject message may be a control message, such as a RRC message. In one or more example methods, the reject message is an RRCReconfigurationFailureSidelink message. This step S105 corresponds to S205 of FIG. 6 and to 510 of FIG. 4, when 510 comprises an indication that the remote WD rejects the DRX configuration. In one or more example methods, the remote WD's capabilities may indicate a level of power sensitivity of the remote WD. In one or more example methods, the capabilities may indicate that the remote WD being power sensitive, such as extra power sensitive, and therefore a DRX scheme should preferably be selected that fits the remote WD's capabilities, such as considers the power requirements of the remote WD, and the assistance information received from the remote WD.

The method 100 comprises determining S107 a DRX configuration to be used for communication between the relay WD and the remote WD. The relay WD may have the final decision on the DRX configuration to be used for the sidelink communication with the relay WD. The DRX configuration to be used can herein be seen as the final DRX configuration that the remote WD has to use for sidelink communication with the relay WD.

In one or more example methods, determining S107 comprises determining S107A the DRX configuration based on the assistance signaling received from the remote WD. In one or more example methods, the relay WD may determine the DRX configuration to be used based on the capabilities for sidelink DRX and/or the first and/or third proposed DRX configuration received from the remote WD.

In one or more example methods, determining S107 comprises determining S107B the DRX configuration based on a current DRX configuration of the relay WD. The current DRX configuration may for example be a Uu DRX configuration of the relay WD, such as a DRX configuration for the communication with the radio network node via the Uu interface. This may be the case when the relay WD is connected to the radio network node via the Uu interface.

In one or more example methods, determining S107 comprises determining S107C the DRX configuration to be used based on a current DRX configuration of a second remote WD. In case the relay WD already has established a sidelink connection with a second WD, the relay WD may determine the DRX configuration for the first WD, such as for the remote WD from which the request to initiate sidelink communication with the relay WD was received, based on an already existing DRX configuration for the second WD. In one or more example methods, the relay WD may determine the DRX configuration of the remote WD, such as of the first remote WD, to correspond to the DRX configuration of the second remote WD. The DRX configurations of the first remote WD and the second remote WD may thus overlap, such that the PFs and/or the POs of the first remote WD and the second remote WD overlap.

In one or more example methods, the DRX configuration to be used is different from the proposed DRX configuration received from the remote WD. In one or more example methods, the relay WD may determine that the proposed DRX configuration is not suitable for the relay WD, for example based on already existing DRX cycles at the relay WD, such as DRX configurations for other remote WDs communicating with the relay WD via sidelink or for the Uu interface.

In one or more example methods, the DRX configuration to be used is the same as the proposed DRX configuration received from the remote WD. The relay WD may, in one or more example methods, accept the proposed DRX configuration received from the remote WD. This may for example be the case when there are no other DRX configurations at the relay WD or when the proposed DRX configuration is aligned with an already existing DRX configuration at the relay WD.

The method 100 comprises transmitting S109, to the remote WD, a second signal. The second signal is indicative of the DRX configuration to be used. The DRX configuration to be used may be transmitted using control signaling, such as in an RRCReconfigurationCompleteSidelink message as defined 3GPP TS 38.331, v. 17.1.0. This step S109 corresponds to S207 of FIG. 6 and to 512 of FIG. 4.

In one or more example methods, the method 100 comprises receiving S111, from the remote WD, an accept message. In one or more example methods, the accept message indicates an acceptance of the DRX configuration to be used. In one or more example methods, the accept message may comprise an acceptance and confirmation of the DRX configuration to be used. In one or more example methods, the accept message may comprise the remote WDs capabilities for sidelink DRX. The accept message may be an RRCReconfigurationCompleteSidelink message. This step S111 corresponds to S209 of FIG. 6, to 514 of FIG. 4, and/or to 510 of FIG. 4 when 510 comprises an indication that the remote WD accepts the DRX configuration.

In one or more example methods, the method 100 comprises implementing S113 the DRX configuration to be used. Implementing S113 the DRX configuration to be used can herein be seen as applying the DRX configuration, such as monitoring the active time configured by the DRX configuration to be used for data to be relayed to and/or from the remote WDs.

FIG. 6 is a flow-chart illustrating an example method 200, performed in a remote wireless device, WD, according to the disclosure, for configuring sidelink discontinuous reception, DRX, of the remote WD. The remote WD is the remote WD disclosed herein, such as any one of the remote WDs 300B, 300BA, 300BB, 300BC of FIGS. 1, 3-4, and FIG. 8.

The method 200 comprises transmitting S201, to a relay WD, a first signal. The first signal is indicative of a request to initiate sidelink communication with the relay WD. The first signal may be transmitted via control signaling. In one or more example methods, the first signal may be transmitted as part of a Direct Communication procedure. This step S201 corresponds to step S101 of FIG. 5 and is similar to 502 of FIG. 4.

In one or more example methods, the method 200 comprises transmitting S203, to the relay WD, assistance signaling. In one or more example methods, the assistance signaling is indicative of a first proposed DRX configuration for communication between the relay WD and the remote WD. The assistance signaling may be indicative of assistance information assisting the relay WD 300A in determining a DRX configuration to be used for communication between the remote WD and the relay WD via sidelink. In one or more example methods, the assistance signaling is indicative of a first proposed DRX configuration for communication between the relay WD and the remote WD. The first proposed DRX configuration may be a DRX configuration desired by the remote WD. In one or more example methods, the assistance signaling may be a UEAssistanceInformationSidelink message as defined in 3GPP TS 38.331, chapter 5.8.9.6. The DRX configuration may comprise one or more of a DRX timing and a DRX period. This step S203 corresponds to 504 of FIG. 4 and step S103 of FIG. 5.

In one or more example methods, the method 200 comprises receiving S204, from the relay WD, a third signal being indicative of a second proposed DRX configuration for communication between the relay WD and the remote WD. This step S204 corresponds to 508 of FIG. 4 and step S104 of FIG. 5.

In one or more example methods, the method 200 comprises transmitting S205, to the relay WD, a reject message. In one or more example methods, the reject message comprises an indication indicating that the remote WD rejects the proposed DRX configuration received from the relay WD. The reject message may be a control message, such as a RRC message. The reject message may for in one or more example methods be an RRCReconfigurationFailureSidelink message. This step S205 corresponds to S105 of FIG. 5 and to 510 of FIG. 4, when 510 comprises an indication that the remote WD rejects the DRX configuration.

The method 200 comprises receiving S207, from the relay WD, a second signal. The second signal is indicative of a DRX configuration to be used. The DRX configuration to be used can herein be seen as the final DRX configuration that the remote WD has to use for sidelink communication with the relay WD. The second signal is indicative of the DRX configuration to be used. The DRX configuration to be used may be transmitted using control signaling, such as in an RRCReconfigurationCompleteSidelink message as defined 3GPP TS 38.331, v. 17.1.0. This step S207 corresponds to S109 of FIG. 5 and to 512 of FIG. 4.

In one or more example methods, the DRX configuration to be used is different from the proposed DRX configuration received from the remote WD. In one or more example methods, the relay WD may determine that the DRX configuration proposed by the remote WD is not suitable for the relay WD, for example based on already existing DRX cycles at the relay WD, such as DRX configurations for other remote WDs communicating with the relay WD via sidelink or for the Uu interface. The remote WD may thus receive a different DRX configuration to be used from the relay WD.

In one or more example methods, the DRX configuration to be used is the same as the proposed DRX configuration received from the remote WD. In other words, the relay WD, may accept the DRX configuration proposed by the remote WD.

In one or more example methods, the method 200 comprises transmitting S209, to the relay WD, an accept message. In one or more example methods, the accept message indicates an acceptance of the DRX configuration to be used. The accept message may be a control message, such as an RRC message. The accept message may, in one or more example methods, be an RRCReconfigurationCompleteSidelink message. This step S209 corresponds to S111 of FIG. 5, to 514 of FIG. 4, and/or to 510 of FIG. 4 when 510 comprises an indication that the remote WD accepts the DRX configuration.

In one or more example methods, the method 200 comprises implementing S211 the DRX configuration to be used. Implementing S211 the DRX configuration to be used can herein be seen as applying the DRX configuration, such as monitoring the active time configured by the DRX configuration to be used for data to be relayed to and/or from the remote WDs.

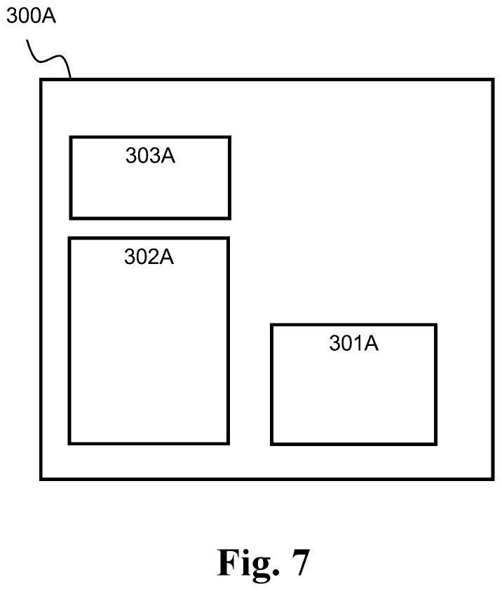

FIG. 7 shows a block diagram of an example relay wireless device, WD, 300A according to the disclosure. The relay WD 300A comprises memory circuitry 301A, processor circuitry 302A, and a wireless interface 303A. The relay WD 300A may be configured to perform any of the methods disclosed in FIG. 5. In other words, the relay WD 300A may be configured for configuring sidelink discontinuous reception, DRX, of a remote WD.

The relay WD 300A is configured to communicate with a remote WD, such as the remote WD disclosed herein, using a wireless communication system. The relay WD 300A may be configured to communicate with a radio network node, such as the radio network node 400 disclosed herein, using the wireless communication system

The wireless interface 303A is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The relay WD 300A is configured to receive, for example, via the wireless interface 303A, from the remote WD, a first signal. The first signal is indicative of a request to initiate sidelink communication with the relay WD.

The relay WD 300A is configured to determine, for example, via the wireless interface 303A, a DRX configuration to be used for communication between the relay WD and the remote WD.

The relay WD 300A is configured to transmit, for example, via the wireless interface 303A, a second signal. The second signal is indicative of the DRX configuration to be used.

Processor circuitry 302A is optionally configured to perform any of the operations disclosed in FIG. 5 (such as any one or more of S101, S103, S104, S105, S107, S107A, S107B, S107C, S109, S111, S113). The operations of the relay WD 300A may be embodied in the form of executable logic routines (for example, lines of code, software programs, etc.) that are stored on a non-transitory computer readable medium (for example, memory circuitry 301A) and are executed by processor circuitry 302A.

Furthermore, the operations of the relay WD 300A may be considered a method that the relay WD 300A is configured to carry out. Also, while the described functions and operations may be implemented in software, such functionality may also be carried out via dedicated hardware or firmware, or some combination of hardware, firmware and/or software.

Memory circuitry 301A may be one or more of a buffer, a flash memory, a hard drive, a removable media, a volatile memory, a non-volatile memory, a random access memory (RAM), or other suitable device. In a typical arrangement, memory circuitry 301A may include a non-volatile memory for long term data storage and a volatile memory that functions as system memory for processor circuitry 302A. Memory circuitry 301A may exchange data with processor circuitry 302A over a data bus. Control lines and an address bus between memory circuitry 301A and processor circuitry 302A also may be present (not shown in FIG. 7). Memory circuitry 301A is considered a non-transitory computer readable medium.

Memory circuitry 301A may be configured to store DRX configurations, and/or remote WD capabilities in a part of the memory.

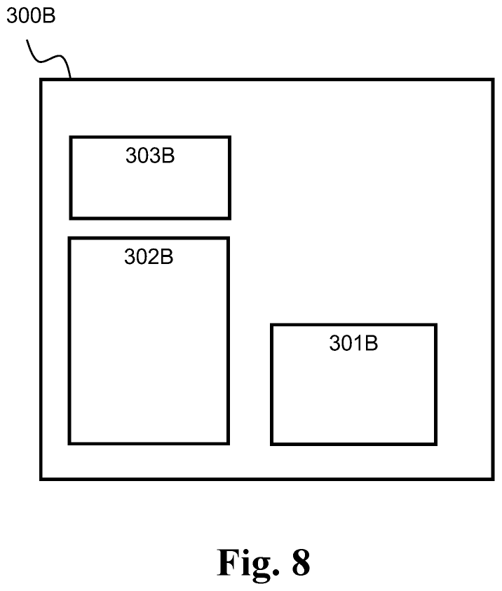

FIG. 8 shows a block diagram of an example remote WD 300B, such as the remote WDs 300BA, 300BB and/or 300BC of FIG. 3, according to the disclosure. The remote WD 300B comprises memory circuitry 301B, processor circuitry 302B, and a wireless interface 303B. The remote WD 300B may be configured to perform any of the methods disclosed in FIG. 6. In other words, the remote WD 300B may be configured for configuring sidelink discontinuous reception, DRX, of the remote WD.

The remote WD 300B is configured to communicate with a relay WD, such as the relay WD disclosed herein, using a wireless communication system.

The remote WD 300B is configured to transmit (such as via the wireless interface 303B), to the relay WD, a first signal. The first signal is indicative of a request to initiate sidelink communication with the relay WD.

The remote WD 300B is configured to receive (such as via the wireless interface 303B), from the relay WD, a third signal. The third signal is indicative of a DRX configuration to be used.

The wireless interface 303B is configured for wireless communications via a wireless communication system, such as a 3GPP system, such as a 3GPP system supporting one or more of: New Radio, NR, Narrow-band IoT, NB-IoT, and Long Term Evolution-enhanced Machine Type Communication, LTE-M, millimeter-wave communications, such as millimeter-wave communications in licensed bands, such as device-to-device millimeter-wave communications in licensed bands.

The remote WD 300B is optionally configured to perform any of the operations disclosed in FIG. 6 (such as any one or more of S201, S203, S204, S205, S207, S209, S211). The operations of the remote WD 300B may be embodied in the form of executable logic routines (for example, lines of code, software programs, etc.) that are stored on a non-transitory computer readable medium (for example, memory circuitry 301B) and are executed by processor circuitry 302B.

Furthermore, the operations of the remote WD 300B may be considered a method that the remote WD 300B is configured to carry out. Also, while the described functions and operations may be implemented in software, such functionality may also be carried out via dedicated hardware or firmware, or some combination of hardware, firmware and/or software.

Memory circuitry 301B may be one or more of a buffer, a flash memory, a hard drive, a removable media, a volatile memory, a non-volatile memory, a random access memory (RAM), or other suitable device. In a typical arrangement, memory circuitry 301B may include a non-volatile memory for long term data storage and a volatile memory that functions as system memory for processor circuitry 302B. Memory circuitry 301B may exchange data with processor circuitry 302B over a data bus. Control lines and an address bus between memory circuitry 301B and processor circuitry 302B also may be present (not shown in FIG. 8). Memory circuitry 301B is considered a non-transitory computer readable medium.

Memory circuitry 301B may be configured to store information such as a DRX, configuration in a part of the memory.

Examples of methods and products (network node and wireless device) according to the disclosure are set out in the following items:
Item 1. A method, performed in a relay wireless device, WD, for configuring sidelink discontinuous reception, DRX, of a remote WD, wherein the method comprises:
   receiving (S101), from the remote WD, a first signal, the first signal being indicative of a request to initiate sidelink communication with the relay WD,
   determining (S107) a DRX configuration to be used for communication between the relay WD and the remote WD, and
   transmitting (S109), to the remote WD, a second signal, the second signal being indicative of the DRX configuration to be used.
Item 2. The method according to Item 1, wherein the method comprises:
   implementing (S113) the DRX configuration to be used.
Item 3. The method according to Item 1 or 2, wherein the method comprises:
   receiving (S103), from the remote WD, assistance signaling, the assistance signaling being indicative of a first proposed DRX configuration for communication between the relay WD and the remote WD.
Item 4. The method according to Item 3, wherein the DRX configuration to be used is different from the first proposed DRX configuration received from the remote WD.
Item 5. The method according to Item 3, wherein the DRX configuration to be used is the same as the first proposed DRX configuration received from the remote WD.
Item 6. The method according to any one of the Items 3 to 5, wherein determining (S107) comprises:
   determining (S107A) the DRX configuration based on the assistance signaling received from the remote WD.
Item 7. The method according to any one of the previous Items, wherein determining (S107) comprises:
   determining (S107B) the DRX configuration based on a current DRX configuration of the relay WD.
Item 8. The method according to any one of the previous Items, wherein determining (S107) comprises:
   determining (S107C) the DRX configuration based on a current DRX configuration of a second remote WD.
Item 9. The method according to any one of the previous Items, wherein the method comprises:
   receiving (S111), from the remote WD, an accept message, the accept message indicating an acceptance of the DRX configuration to be used.
Item 10. The method according to any one of the previous Items, wherein the method comprises:
   transmitting (S104), to the remote WD, a third signal being indicative of a second proposed DRX configuration for communication between the relay WD and the remote WD.
Item 11. The method according to Item 10, wherein the method comprises:
   receiving (S105), from the remote WD, a reject message, the reject message indicating a rejection of the second proposed DRX configuration received from the relay WD.
Item 12. A method, performed in a remote wireless device, WD, for configuring sidelink discontinuous reception, DRX, of the remote WD, wherein the method comprises:
   transmitting (S201), to a relay WD, a first signal, the first signal being indicative of a request to initiate sidelink communication with the relay WD, and
   receiving (S207), from the relay WD, a second signal, the second signal being indicative of a DRX configuration to be used.
Item 13. The method according to Item 12, wherein the method comprises:
   implementing (S211) the DRX configuration to be used.
Item 14. The method according to Item 12 or 13, wherein the method comprises:
   transmitting (S203), to the relay WD, assistance signaling, the assistance signaling being indicative a first proposed DRX configuration for communication between the relay WD and the remote WD.
Item 15. The method according to Item 14, wherein the DRX configuration to be used is different from the first proposed DRX configuration transmitted by the remote WD.
Item 16. The method according to Item 14, wherein the DRX configuration to be used is the same as the first proposed DRX configuration transmitted by the remote WD.
Item 17. The method according to any one of the Items 12 to 16, wherein the method comprises:
   transmitting (S209), to the relay WD, an accept message, the accept message indicating an acceptance of the DRX configuration to be used.
Item 18. The method according to any one of the Items 12 to 17, wherein the method comprises:
   receiving (S204), from the relay WD, a third signal being indicative of a second proposed DRX configuration for communication between the relay WD and the remote WD.
Item 19. The method according to Item 18, wherein the method comprises:
   transmitting (S205), to the relay WD, a reject message, the reject message indicating a rejection of the second proposed DRX configuration received from the relay WD.
Item 20. A relay wireless device comprising memory circuitry, processor circuitry, and a wireless interface, wherein the relay wireless device is configured to perform any of the methods according to any of Items 1-11.
Item 21. A remote wireless device comprising memory circuitry, processor circuitry, and a wireless interface, wherein the remote wireless device is configured to perform any of the methods according to any of Items 12-19.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1-8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed in a relay wireless device (WD) for configuring sidelink discontinuous reception (DRX) of a remote WD, wherein the method comprises:
receiving, from the remote WD, a first signal, the first signal being indicative of a request to initiate sidelink communication with the relay WD,
determining a DRX configuration to be used for communication between the relay WD and the remote WD, and
transmitting, to the remote WD, a second signal, the second signal being indicative of the DRX configuration to be used.

2. The method according to claim 1, wherein the method comprises:
implementing the DRX configuration to be used.

3. The method according to claim 1, wherein the method comprises:
receiving, from the remote WD, assistance signaling, the assistance signaling being indicative of a first proposed DRX configuration for communication between the relay WD and the remote WD.

4. The method according to claim 3, wherein the DRX configuration to be used is different from the first proposed DRX configuration received from the remote WD.

5. The method according to claim 3, wherein the DRX configuration to be used is the same as the first proposed DRX configuration received from the remote WD.

6. The method according to claim 3, wherein determining comprises:
determining the DRX configuration based on the assistance signaling received from the remote WD.

7. The method according to claim 1, wherein determining comprises:
determining the DRX configuration based on a current DRX configuration of the relay WD.

8. The method according to claim 1, wherein determining comprises:
determining the DRX configuration based on a current DRX configuration of a second remote WD.

9. The method according to claim 1, wherein the method comprises:
receiving, from the remote WD, an accept message, the accept message indicating an acceptance of the DRX configuration to be used.

10. The method according to claim 1, wherein the method comprises:
transmitting, to the remote WD, a third signal being indicative of a second proposed DRX configuration for communication between the relay WD and the remote WD.

11. The method according to claim 10, wherein the method comprises:
receiving, from the remote WD, a reject message, the reject message indicating a rejection of the second proposed DRX configuration received from the relay WD.

12. A method, performed in a remote wireless device, WD, for configuring sidelink discontinuous reception, DRX, of the remote WD, wherein the method comprises:
transmitting, to a relay WD, a first signal, the first signal being indicative of a request to initiate sidelink communication with the relay WD, and
receiving, from the relay WD, a second signal, the second signal being indicative of a DRX configuration to be used.

13. The method according to claim 12, wherein the method comprises:
implementing the DRX configuration to be used.

14. The method according to claim 12, wherein the method comprises:
transmitting, to the relay WD, assistance signaling, the assistance signaling being indicative a first proposed DRX configuration for communication between the relay WD and the remote WD.

15. The method according to claim 14, wherein the DRX configuration to be used is different from the first proposed DRX configuration transmitted by the remote WD.

16. The method according to claim 14, wherein the DRX configuration to be used is the same as the first proposed DRX configuration transmitted by the remote WD.

17. The method according to claim 12, wherein the method comprises:
transmitting, to the relay WD, an accept message, the accept message indicating an acceptance of the DRX configuration to be used.

18. The method according to claim 12, wherein the method comprises:
receiving, from the relay WD, a third signal being indicative of a second proposed DRX configuration for communication between the relay WD and the remote WD.

19. The method according to claim 18, wherein the method comprises:
transmitting, to the relay WD, a reject message, the reject message indicating a rejection of the second proposed DRX configuration received from the relay WD.

20. A relay wireless device comprising memory circuitry, processor circuitry, and a wireless interface, wherein the relay wireless device is configured to perform any of the methods according to claim 1.

21. (canceled)
